(19) United States
(12) Patent Application Publication
(10) Pub. No.: US 2026/0109554 A1
(43) Pub. Date: Apr. 23, 2026

(54) TRANSFER SYSTEM AND METHOD FOR TRANSFERRING PRODUCTS TO TRANSPORT MEANS

(71) Applicant: Gerhard Schubert GmbH, Crailsheim (DE)

(72) Inventor: Markus Riek, Crailsheim (DE)

(73) Assignee: Gerhard Schubert GmbH, Crailsheim (DE)

(21) Appl. No.: 19/363,259

(22) Filed: Oct. 20, 2025

(30) Foreign Application Priority Data
Oct. 21, 2024 (DE) 10 2024 130 602.5

(51) Int. Cl. B65G 47/90; B65B 35/16; B65B 43/46; B65B 57/10

(52) U.S. Cl. CPC B65G 47/90; B65B 35/16; B65B 43/46; B65B 57/10; B65G 2201/0202

(57) ABSTRACT

Disclosed are transfer systems and methods for transferring products to transport means which accommodate a specific amount of products. The transfer system includes at least one moving product supply device, at least one transport device, and at least one transfer device for transferring the products from the product supply device to the transport means in a transfer area, where the transport device has at least a first section along which the products are transported by the transport means in a conveying direction of the product supply device and at least one second section along which the products are transported by the transport means in the opposite direction to the conveying direction of the product supply device.

### CROSS REFERENCE TO RELATED APPLICATION

This application claims priority to German Patent Application No. 10 2024 130 602.5, filed in Germany on Oct. 21, 2024, the entire contents of which are hereby incorporated herein by this reference.

### DESCRIPTION

The present invention relates to a transfer system for transferring products to transport means, which accommodate a specific amount of products, as well as a method for transferring products to transport means by means at least one transfer device of a transfer system.

Transfer systems are often used for transferring products, such as chocolates or baked goods, from a conveyor device in the form of a product belt to designated transport means, such as containers. Such transfer systems, which are known, among other things, as picker lines or picker systems, comprise, in addition to the product supply device, at least one, but usually several, transfer devices aligned parallel to the product supply device. These transfer devices are configured to pick up the products from the product supply device and transfer them to transport means, for example, into transport means in the form of a chocolate box. The overall objective of a transfer system is to fill the transport means completely with a predetermined number of products so that the transport means can then be further manipulated, for example packaged, prepared for sale, and transported.

The transfer devices must be extremely delicate in order to avoid damaging or deforming the products being transferred. In this context, the packaging industry has found it useful to use flexible, adaptable, and precisely controllable robots as transfer devices in order to fill transport means with high speed and precision. These robots are also referred to as pick-and-place machines or pickers and can be equipped with gripping or suction units, for example, for product transferring. Such robots can be configured in the so-called Scara configuration, i.e., as horizontal articulated arm robots, or in the so-called Delta configuration, i.e., as parallel arm robots with rod kinematics.

The transport means are usually arranged on their own transport device, which is aligned adjacent to and parallel to the product supply device, so that the arms of the transfer devices have to cover a shortest possible distance when transferring the products, which in turn increases the efficiency of the transfer system. In addition, the transport device, which is configured as a chain conveyor, for example, comprises drive means for moving the transport means relative to the products on the product supply device. Here, the arrangement of two transport devices, each of which being on one side of the product supply device, is possible and also common.

Originally, the products were transferred according to the so-called synchronous principle, i.e., the transport device moved the transport means along a transport direction that corresponds to the conveying direction of the product supply device and, accordingly, to a conveying direction of the products. Consequently, each transport means passes through a working or transfer area of each of the transfer devices of the transfer system arranged in series, which, in addition to increasing the efficiency of product transfer to the transport means, for example the filling of the containers, and the removal of the filled transport means is also simplified.

Some time ago, however, it became apparent that the efficiency of the transfer system could be increased by using the so-called counter principle in comparison to the synchronous principle. In the counter principle, the transport means to be filled are moved in the opposite direction to the direction in which the product supply device conveys, thereby causing the transport means to only pass the start of the product supply device at the end of the transport by the transport device, where the density of the products on the product supply device is highest. By controlling the transfer devices accordingly, it can thus be ensured that for each transport means there are still sufficient products on the product supply device at the end of filling to ensure complete filling. This is particularly advantageous if there are irregularities in the product supply device with regard to the frequency and position of the products.

In principle, the use of the counter principle enables a more uniform transport or conveying speed of the transport device and the product supply device compared to the synchronous principle. In particular, an undesirable reduction in the performance of the transfer system is avoided, and there is hardly any product overflow, i.e., for the products to be transferred. As there is usually at least one transport means to be filled in the transfer area of a transfer device.

Reference is made here to DE 10 2011 014 697 A1 of the present applicant, in which the mode of operation of transfer systems in synchronous principle and counter principle, respectively, is explained and which is hereby incorporated by reference.

However, it has been shown that counter transfer systems often require relatively long product supply devices in the form of product belts and correspondingly parallel transport devices in order to ensure sufficiently high efficiency when filling the transport means. Such transfer systems are therefore relatively space-intensive, which is particularly problematic in smaller production sites. Furthermore, the length of the transfer system often increases the number of transfer devices used, which means that the acquisition and maintenance costs of the transfer system are increased.

In practice, another problem has emerged for transfer systems that have two independent transport devices. Each of the two transport devices, which are each arranged along one of the two long sides of the product supply device, a manipulation unit is usually provided. This manipulation unit should be accessible from at least one side and is configured to receive the filled transport means from the transport device and to process them further, for example, by removing them from the transfer system. For cost reasons and/or, depending on the arrangement of the transfer system at a production site, due to poor accessibility, often only one of the two manipulation units is used. As a result, the performance of the transfer system is reduced. In addition, in this case, the transfer devices can only transfer to one side of the transfer system, i.e., to one of the two transport devices, which means that the transfer devices must be coordinated and set up accordingly.

It is therefore the objective of the present invention to provide a transfer system for transferring products to transport means which can accommodate a specific amount of products, wherein the transfer system has a sufficiently high efficiency to completely fill (load) the transport means and can be operated in a space-saving and cost-efficient manner.

According to the invention, this task is solved in a first aspect by a transfer system for transferring products to transport means which can accommodate a specific amount of products, wherein the transfer system comprises at least one moving product supply device on which the products can be conveyed along a conveying direction, at least one transport device, which is configured to move the transport means, and at least one transfer device for transferring the products from the product supply device to the transport means in a transfer area, wherein the transport device moves the transport means at least through the transfer area, and wherein the product supply device and the transport device are at least parallel to each other in sections, wherein the transport device has at least a first section along which the products are transported by the transport means in the conveying direction of the product supply device, and at least a second section along which the products are transported by the transport means in the opposite direction to the conveying direction of the product supply device.

The transport means are in particular containers to be filled, for example cartons, boxes or crates, or at least one conveyor belt. A conveyor belt can be used if products, for example flat biscuits, are to be placed or stacked individually on the conveyor belt during transferring by the transfer device. In this case, stacking by transferring a predetermined stack size can be achieved. In order to hold the stacks in their respective positions during transport by the transport device and to separate the stacks from each other, so-called drivers can be arranged along the main direction of a conveyor belt. The individual stacks can be transferred from the transport device to a manipulation unit and further be processed there, for example, by being packaged in stacks by a tubular bag machine.

The transport means can be part of the transport device, especially if a conveyor belt is used as the transport means. Such transport means transport the products only temporarily during operation of the transfer system. Alternatively, the transport means may be separate components that may be part of the transfer system or may be assigned to the products and not be part of the transfer system, in particular if containers are used as transport means, which are later handled as a unit together with the products, for example by being packaged.

Products within the meaning of the present invention can be individual products, in particular single-piece objects, but also a group of individual products that are grouped together for joint manipulation so that they can, for example, be picked up and transferred by the transfer device. In such a group of individual products, the individual products can be transferred together, in particular be held together, for example in pre-packaging. The pre-packaging, including the individual products contained therein, then forms a product within the meaning of the present invention.

Within the meaning of the present invention, the transferring of the products and the filling of the transport means is understood to mean the picking up of the products from the product supply device by the at least one transfer device, in particular by gripping or suction, and the subsequent placing of the products to be transferred in or on the transport means, which are moved by the at least one transport device. If the transport means are containers, these are filled in the course of transferring. In the case of a conveyor belt, the products are transferred to the conveyor belt individually or in stacks, as mentioned above. This case is also understood as filling the transport means or filling the conveyor belt within the meaning of the invention.

Within the meaning of the present invention, the transport means can be assigned a predetermined capacity for receiving products, which is defined as a predetermined number of products per distance along the transport direction of the transport device. If the transport means are containers, each transport means has a predetermined capacity for products, depending in particular on the transport means size, the number of storage spaces within the transport means, etc. If the transport means are conveyor belts, the capacity can be determined by the width of the conveyor belt, the size of the products placed on it, and/or the process-related distance between the products, etc. For example, carriers may be arranged along the conveyor belt or other compartments may be provided which define storage spaces for products. If the products are to be stacked on the conveyor belt, the storage capacity takes into account a predetermined stacking height or number of products in a complete stack. Filling the transport means by means of a transfer system according to the invention preferably achieves complete filling of the transport means with products at the outlet of the transport device (in the transport direction at the end of the second section of the transport device), which means that the receiving capacity of the transport means at the outlet of the transport device is exhausted. As a result, for example, a packaging device at the outlet of the transport device can reliably and effectively operate at the outlet of the transport device.

The product supply device is preferably configured as a product belt on which the products are conveyed along a conveying direction through the transfer system according to the invention. In this case, a single, continuous product belt or several product belts running in the same direction may be provided. In particular, two or more product belts, all of which are comprised by the product supply device, may be arranged parallel to each other along the main direction of extension of the transfer system. In this case, at least one transfer device may be provided for each of the parallel product belts. Alternatively, other product supply devices are also conceivable.

To drive and control the product supply device and the transport device, the transfer system according to the invention may comprise first control and drive devices. The first control and drive devices are configured in particular to control the speed of the product supply device and the transport device in order to be able to adjust the relative speed of the products and the transport means. If, for example, more products are on the product supply device at a specific point in time than the transport means provided can accommodate at a specific point in time, the speed of the product supply device can be reduced via the first control and drive devices in order to prevent product overflow. Preferably, however, the speed of the product supply device is kept constant and, if necessary, the speed of the transport means is increased. The first control and drive devices may also be capable of moving the transport means, which are moved by the transport device, independently of one another. Likewise, the product supply device and/or transport device can be stopped during the transfer process if necessary.

In the context of the present invention, moving the transport means by means of the transport device is understood in particular to mean transporting containers or driving a conveyor belt along a transport direction. Following transferring by the transferring device, the products are transported by the transport means, i.e., either in the containers or on the conveyor belt.

Furthermore, second control and drive devices may be provided for driving and controlling the transfer device relative to the product supply device and the transport device, i.e., for transferring the products. In addition, feedback control may be established between the first and second control and drive devices so that the transfer speed of the transfer device can be adjusted according to the conveying speed of the products on the product supply device and the transport speed of the transport means. The second control and drive devices may also be set up to prioritize transport means based on the current fill level or the current fill amount of the transport means. For example, transport means that are already in an end section of the transport device can be served with high priority in order to ensure that these transport means are completely filled.

In the context of the present invention, a transfer area is understood to be an area in which the transfer device picks up products from the product supply device and carries out transferring to a specific transport means, i.e. the working area of the transfer device in the transfer system. A distinction can be made between a potential transfer area and an actual transfer area. The potential transfer area is understood to be the maximum working area of the transfer device, which it could serve with its arms or robot arms. In contrast, the actual transfer area represents a limitation of the potential transfer area, namely to the working area required for filling the transport means. Determining the actual transfer area is particularly useful if several transfer devices are provided in a transfer system in order to rule out the risk of collision between the arms of the transfer devices when transferring the products.

According to the invention, the product supply device and the transport device run parallel to each other at least in sections. This means that both the product supply device and the transport device each have at least one section in which the products and the transport means are moved parallel to each other along their respective conveyor and transport directions. The parallel sections extend in particular along the main extension direction of the transfer system and across the transfer area of the at least one transfer device. Furthermore, the parallel sections preferably correspond to at least 50% of the total length of the product supply device or the transport device, and particularly preferably at least 75%. As a result, the product supply device and the transport device run in particular parallel in relation to their entire length, which simplifies the movement of the transferring device during the transferring process. On the other hand, alternative configurations are also conceivable in which the aforementioned value of 50% may be exceeded, since product belts could theoretically be of any length or could also run through two systems.

According to an important feature of the present invention, the transport device has at least a first section and a second section, wherein transport of the products by the transport means (transport direction) in the first section is in the conveying direction of the product supply device. In contrast, the transport of the products by the transport means (transport direction) in the second section runs in the opposite direction to the conveying direction of the product supply device. In other words, the first section corresponds to a section running in the same direction as the conveying direction of the product supply device, and the second section corresponds to a section running in the opposite direction. Consequently, the present invention combines the synchronous principle and the counter principle in one transfer system. It has been found that the combination of parallel and counter principle enables the transferring of the products to transport means with high efficiency without incurring the aforementioned disadvantages of the synchronous principle.

By having both the first and second sections as part of a transport device extending through the transfer area of the at least one transfer device, the latter can fill the transport means in each of the two sections accordingly and, if necessary, i.e., in particular depending on the fill level of the transport means, prioritize either the first, synchronous section or the second, counter section. Alternatively, when using several transfer devices, the transfer device can be configured in such a way that it can be switched between the two sections. It is also conceivable that the transfer devices are arranged in the transfer system in such a way that at least one first transfer device is assigned to the first section and at least one second transfer device is assigned to the second section, i.e., exclusively serves the respective section of the transport device. In any case, the first and second sections are arranged in such a way that they extend through the transfer area of at least one transfer device. Preferably, the first section of the transport device is configured to be parallel and immediately adjacent to one of the two long sides of the elongated product supply device, while the second section of the transport device is configured analogously on the opposite long side of the product supply device. In addition, the first and second sections may also run parallel to each other; in particular, they are configured to be analogous or approximately symmetrical to each other along the transfer area of the transfer device relative to an axis of symmetry which runs along the main direction of extension of the product supply device through its center.

Optionally, the first section and/or the second section may have substantially the same length as the product supply device along the transfer area of the at least one transfer device. The total length of the first and second sections may also be the same or different, in which case the second section is preferably longer than the first section so that the counter section of the transport device can be relatively larger than the synchronous section.

The transport of the transport means by means of the transport device through the transfer area begins in particular in the first section and ends in the second section, whereby the transport means are first transported in the conveying direction of the product supply device and then in the opposite direction. Consequently, when a transfer process is initiated, the transport means first pass through the synchronous section and then through the counter section.

In contrast to known counter transfer systems, the transfer system according to the present invention has the advantage that the at least one transfer device can perform the transferring of products from the product supply device to the transport means, which comprise the first and second sections, on both sides of the product supply device, i.e., relative to the main direction of extension of the product supply device, but only one transport device needs to be used. Consequently, compared to conventional counter transfer systems, both space and costs can be saved while maintaining the same efficiency.

In a preferred embodiment of the transfer system according to the invention, a third section of the transport device may extend between the at least one first section and the at least one second section, which is configured to transfer the products from the first section to the second section. The third section thus functions as a transfer passage between the first, synchronous section and the second, counter section, which, as part of the transport device, can run along the product supply device, in particular parallel to each other, and connects them. The third section is configured to ensure a smooth transition between the first section and the second section of the transport device, whereby the products and, correspondingly, the transport means move during transport in the third section relative to the conveying direction of the product supply device on the conveyor belt.

Optionally, the third section of the transport device can be arranged at a face-side end of the transfer system so that the transport device is circumferentially formed on the face side of the transfer system. In other words, the transport device can surround the transfer system or the product supply device through the first and second sections on both long sides and additionally through the third section on a face side of the product supply device. In this context, the end of the product supply device along its conveying direction is understood to be the end side of the product supply device.

In a further embodiment of the transfer system according to the invention, the first, second, and third sections of the transport device can form a U-shaped arrangement when viewed from above the transfer system. The U-shaped arrangement may, for example, correspond to a right-angled arrangement in which the first and second sections run parallel to each other and the third section is arranged at right angles to them. In this case, a transition area may be provided between the first and third sections and between the third and second sections, in which the orientation of the transport means on the transport device is aligned with the subsequent area. The right-angled arrangement of the third section immediately adjacent to the face-side end of the product supply device is particularly space-saving. Alternatively, the third section may also be curved in the top view or have at least one curved transition area, so that the transport means can be easily moved from the first section of the transport device to the second section of the transport device by means of the third section.

To transfer the products from the first section to the second section, the third section may also be equipped with manipulating means, wherein the manipulating means comprise at least one selected from the group of link or curved chains, curved belts, or a robot. The manipulating means are configured in particular to pick up the products and/or the transport means in the first section individually, in groups, or in stacks and to convey them to the second section, for example by transferring stacked products or by transferring the transport means. In this respect, if the transport means are in the form of containers to be filled, the manipulating means may be configured as robots. In particular, this may be an industrial robot with a manipulator and effector, which, for example, grasps or sucks the containers and is thereby able to performing transferring of the containers from the first section to the second section. When using a conveyor belt, on the other hand, the manipulating means are preferably configured as a curved chain or curved belt.

In an optional embodiment of the transfer system according to the invention, the transfer area of the at least one transfer device can comprise the first section and the second section of the transport device or the first, second, and third sections of the transport device. If desired, the transfer device can thus be capable of filling the transport means in the third section in addition to the first and second sections. In this context, a separate transfer device can optionally be provided, which transfers the products from the end of the product supply device or, if applicable, products that have been conveyed from the end of the product supply device to a downstream collection area, into the transport means located in the third section.

If the transfer system according to the invention comprises only one transfer device, the transfer device can be configured to fill transport means both in the first section and in the second section of the transport device. In this case, the transfer device is capable of transferring the products on both sides from the product supply device into the first or second section. If several transfer devices are provided, the transfer device located last in the transport direction of the transport means may have the aforementioned property. Alternatively, the at least one transfer device may be assigned only to the first section or only to the second section of the transport device. This means that a specified, actual transfer area of the corresponding transfer device is limited to either at least one subsection of the first section or at least one subsection of the second section. This embodiment is particularly practicable when several transfer devices are arranged in groups, for example in pairs, along the main direction of extension of the product supply device, so that a first transfer device from a group of transfer devices serves the first section and a second transfer device from the group of transfer devices serves the second section. In addition, a transfer device located at the end of the transport direction of the transport means may be assigned to the second section of the transport device.

In a preferred embodiment of the transfer system according to the invention, at least one manipulation unit is arranged downstream of the second section of the transport device, which is configured to manipulate the products or the transport means filled with products. Manipulating the products or the transport means refers in particular to their removal from the transport device and their further processing, for example their packaging. The manipulation unit is preferably arranged downstream of the transport device in such a way that it is accessible from at least one side, for example, so that it can be operated and maintained manually.

Furthermore, the transport device of the transfer system according to the invention may comprise transport carriages which can be moved independently of one another along the transport device, each transport carriage being configured to move at least one transport means, in particular at least one container to be filled. The transport carriages can be driven by the transport device via a mechanical drive, for example by means of a toothed rack and pinion, or an electric drive. The transport carriages can be adaptable depending on the size and shape of the transport means and, if necessary, can be equipped with additional devices, for example a transport means-specific receptacle or tray, in order to transport a transport means securely on a transport carriage. The fact that the transport carriages can be moved independently of one another means that the transport speed of individual transport means can be adjusted individually. This means, for example, that transport means that are already completely filled can be accelerated in order to remove them from the transport device.

Optionally, the transport device may comprise at least one first guideway and at least one second guideway, each of which is configured to accommodate a plurality of transport carriages and to move them independently of each other, wherein the first guideway accommodates those transport carriages which move transport means to be filled with products, and the second guideway accommodates those transport carriages which return empty transport means to a start of the first guideway. Furthermore, the first and second guideways can be arranged above each other within the transport device or next to each other within the transport device. The first and second guideways can thus be operated parallel to each other and ensure that there are always enough transport carriages available at the start of the transport device. Accordingly, the two guideways form a kind of circuit system for transporting the transport carriages. The empty transport means, which are moved by means of the transport carriages via the second guideway can be gripped by the transport carriages, for example, using a gripping or suction unit specifically configured for this purpose.

In a further embodiment of the transfer system according to the invention, the transport device may be configured to invert the transport direction of the transport means. In other words, the transport means can be moved forwards and backwards on the guideways, optionally via the transport carriage. If the transport direction of the transport means is inverted, then consequently, the first section becomes the counter section and the second section becomes the synchronous section. In particular, the transport direction can be inverted without having to interrupt or stop the transfer process, whereby the efficiency of the transfer system remains constant.

Furthermore, a second manipulation unit may be provided, which is set up analogously to the aforementioned first manipulation unit. The second manipulation unit may be arranged at the beginning of the transport device or the first manipulation unit, respectively, so that in the event of the transport direction being reversed, the transport means can be switched from the first manipulation unit to the second manipulation unit and the filled transport means consequently enter the second manipulation unit after leaving the first section.

In order to compensate for a failure of the transport device, which can occur, for example, due to technical defects during operation, without any loss of efficiency or performance of the transfer system, the transport device of the transfer system according to the invention can be configured in a preferred embodiment to comprise a first transport device and a second transport device separate from the first transport device. The first transport device and the second transport device can each have at least one first section along which the products are transported by the transport means in the conveying direction of the product supply device, and can have at least a second section along which the products are transported by the transport means in the opposite direction to the conveying direction of the product supply device. This provides two separate transport devices which can be selectively loaded with products by the transfer device, so that redundant transfer system is provided.

In particular, a first manipulation unit may be arranged downstream of the second section of the first transport device, which is configured to manipulate, in particular to package, the products transported by the first transport device, and subsequently to the second section of the second transport device a second manipulation unit may be arranged, which is configured to manipulate the products transported by the second transport device, in particular to package them. In this way, the manipulation units are also provided redundantly.

The two redundant transport devices can be arranged on the product supply device in such a way that they save space and are easily accessible for the transfer device, with the first section of the first transport device and the first section of the second transport device located on different sides of the product supply device relative to a longitudinal center axis of the product supply device, and/or with the second section of the first transport device and the second section of the second transport device arranged on different sides of the product supply device relative to a longitudinal central axis of the product supply device, and/or with the first manipulation unit and the second manipulation unit arranged on different sides of the product supply device relative to a longitudinal central axis of the product supply device.

The first transport device is in particular the transport device described above, whereby the second transport device may substantially have the same features and properties. The two manipulating units can also be coupled to the respective transport device in accordance with the principles described above. In addition, the first manipulating unit immediately following the second section of the first transport device can be coupled to the second transport device at the same time and the second manipulating unit immediately following the first section of the first transport device may also be coupled accordingly with the second transport device, so that when the transport direction of the transport means is reversed by the first or second transport device, the handling of the filled transport means is ensured.

If the first transport device and/or one of the two manipulating units fails, for example due to a technical defect or maintenance work, or if the first transport device is at a standstill for other operational reasons, the second transport device can be activated instead and the at least one transfer device can be caused to transfer transport means on the second transport device instead of transport means on the first transport device to fill the first transport device. Alternatively, the first and second transport devices can also be operated simultaneously.

In an optional embodiment, the transfer system according to the invention may comprise at least one camera or sensor which monitors the transfer process, i.e. the transfer of the products in the transfer area of the at least one transfer device. The camera or sensor may in particular be configured to monitor the first, second, and third sections of the transport device, including the moving transport means, as well as the products on the product supply device. Based on the information provided by the camera or sensor, the transfer device can be controlled in such a way that the products are transferred to the next transport device. The control of the transport device, the transfer speed, and the control of specific transport means by the transfer device can be adjusted. Accordingly, the transport speed of the transport carriages in the various sections of the transport device can also be adjusted.

If, for example, the camera or sensor detects that one or more transport means at the end or outlet of the counter section are not yet completely filled, the transfer device responsible for this section can be controlled accordingly in order to ensure complete filling of the transport means. Due to feedback from the camera or sensor an emergency system may be established that recognizes, in particular, product overflows on the product supply device and incompletely filled transport means, and initiates appropriate countermeasures. It is also conceivable that the camera or sensor is set up to monitor at least one manipulating unit.

Furthermore, each transfer device of the transfer system can be provided with its own camera or sensor, which is configured to determine the fill level or fill amount of a specific transport means, in particular immediately before and/or immediately after filling this transport means with a product. The transfer devices can then continuously report the determined fill levels of the transport means to the first and second control and drive devices, so that the fill levels of any transport means located in the transfer system can be automatically recorded and thus monitored. If one of the transfer devices of the transfer system fails, the remaining active transfer devices can be controlled based on the information about the currently available fill levels in order to ensure that all transport means are filled.

The present objective is solved in a second aspect by a method for transferring products to transport means by means of at least one transfer device of a transfer system, wherein the method comprises moving the transport means to be filled by means of at least one transport device through at least one transfer area in which the transfer device is located, and filling the transport means by means of the transfer device transferring products from at least one moving product supply device, which runs at least in sections parallel to the transport device, to the transport means to be filled, wherein the products are transferred to the transport means both in a first section, along which the products are transported by the transport means in a conveying direction of the product supply device, and in a second section of the transport device along which the products are transported by the transport means in the opposite direction to the conveying direction of the product supply device.

The method according to the invention can be carried out in particular with a transfer system according to the first aspect, whereby it should be explicitly noted at this point that all aspects relating to the first and second aspects can also be applied and combined with the respective other aspect.

Consequently, the transport means can be moved by means of the transport device from the first section via a third section of the transport device to the second section, whereby the third section is preferably arranged on a face-side end of the transfer system in such a way that the transport device extends on a face side around the face-side end of the transfer system.

Optionally, the first control and drive devices for driving the product supply device and the transport device, and the transport speed of the products on the product supply device can be controlled independently of the transfer speed of the transfer device in the first and second sections of the transport device. Consequently, one or more relative speeds can be adjustable, which relate to the transport speed of the individual transport means, optionally to the transport carriage of the transport device, in the individual sections.

In particular, the transport speed of the transport means can be determined based on the transfer speed of the last transfer device along the transport direction of the transport means. This transfer device is also referred to as the master transfer device, as it is the last transfer device responsible for finally filling incompletely filled transport means. If, at any given time, there are an above-average number of incompletely filled transport means in the transfer area of the last transfer device, the transport speed of the products and/or the transport speed of the transport means can be reduced, for example. Otherwise, the transport speed can be increased if, relative to the available quantity of products, there is a surplus of available or not fully utilized transfer devices.

In a further embodiment of the method according to the invention, the at least one transfer device can be controlled via the second control and drive devices in such a way that priority is given to filling a transport means as long as the transport means is located in the first section of the transport device. Accordingly, the aim is to fill the transport means as much as possible in the synchronized section, which means that less time must be allocated for the transport means to be completely filled in the counter section. This reduces in particular the workload of the last transfer device in the transport direction of the transport means, which in turn reduces the risk of incompletely filled transport means.

In a preferred embodiment of the method according to the invention, the transport device may comprise a first transport device and a second transport device separate from the first transport device, as already described above in a variant of the first aspect. According to the method of the second aspect of the invention, the operation of a such a transfer system can then be switchable between a first operating mode, in which the transfer device transfers the products only to transport means of the first transport device, while the second transport device and/or the second manipulating unit is/are preferably inactive, and a second operating mode, in which the transfer device transfers the products only to transport means of the second transport device, while the first transport device and/or the first manipulating unit is/are preferably inactive.

In particular, switching from the first operating mode to the second operating mode can be performed substantially without interrupting the movement of the product supply device, in particular in order to allow maintenance or repair of a component associated with the first transport device, for example a manipulation unit, to switch seamlessly from the first transport device to the second transport device.

In this context, it is conceivable that a first operating mode is provided in which the at least one transfer device operates a first, active transport device. If the first transport device fails or is shut down for other reasons, the transfer system activates a second operating mode. In this second operating mode, the at least one transfer device switches from the first transport device to the second transport device and from then on only operates the latter. Optionally, a third operating mode can be set up in which the at least one transfer device operates both the first transport device and the second transport device.

If the transfer system comprises a plurality of transfer devices, in the event of failure of one transfer device, the remaining active transfer devices can be controlled in such a way that efficient operation of the transfer system can be ensured, if necessary by switching from the first transport device to the second transport device or vice versa.

Furthermore, specific fill levels or fill amounts of the transport means can be provided in the first and second sections of the transport device, and if necessary also in the third section, so that the transfer device fills a transport means, for example, to 50% in the first, synchronous section and the remaining 50% in the second, counter section. It is also conceivable that specific transport means or specific parts of the transport means are only filled in one of the sections, for example, that every second transport means is alternately filled in either the first or the second section.

Furthermore, a filling sequence can be specified in which the transfer devices fill the transport means. If the transport means are configured in the form of containers, for example, a first specific filling position within the transport means can always be filled by the first transfer device along the transport direction of the transport means, while the subsequent transfer device always serves a second specific filling position, etc.

This filling sequence can also be continued if one of the transfer devices fails. In general, the transfer process can be adjusted in terms of transfer and transport speed according to the quantity of products on the product supply device.

Finally, it should be noted that both the transfer system of the first aspect and the method according to the second aspect enable efficient filling of the transport means, in which the number of manipulation units can be varied as required, whereby maximum performance is ensured even when using a single manipulation unit. Consequently, the transfer system can be configured to be relatively small, i.e., in contrast to conventional counter transfer systems, it can comprise, in particular, a shorter product supply device and fewer transfer devices.

### BRIEF DESCRIPTION OF THE DRAWINGS

The transfer device according to the invention is described in greater detail below with reference to the accompanying drawings. It shows:

FIG. 1 A top view of a section of a transfer system according to the invention according to a first embodiment;

FIG. 2 a cross-sectional view of the transfer system of FIG. 1;

FIG. 3 a top view of a transfer system with a transport device according to the first embodiment; and

FIG. 4 a top view of a transfer system with first and second transport devices according to a second embodiment.

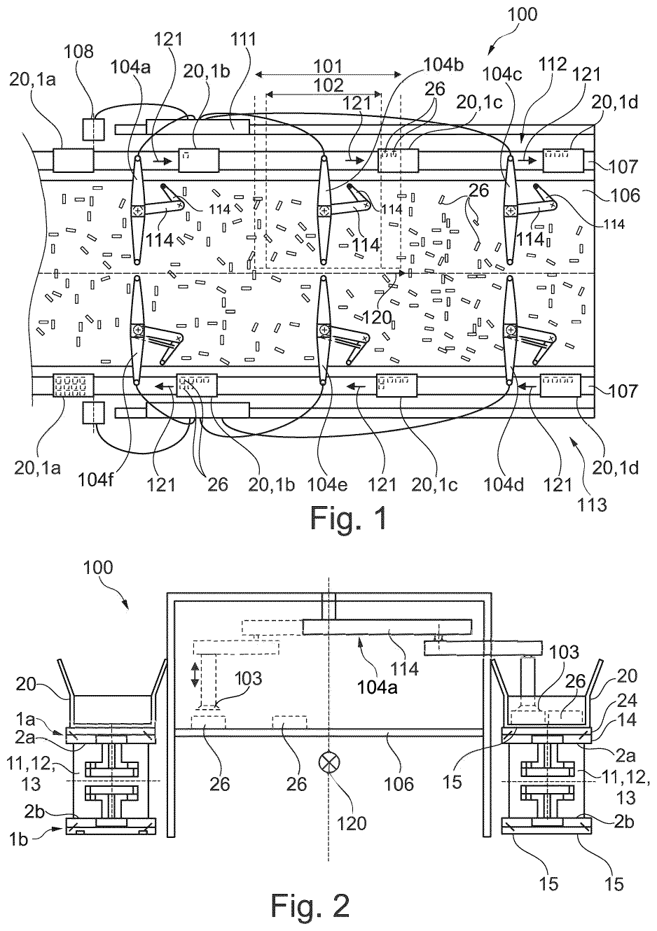

FIG. 1 shows a top view of a portion of a transfer system 100 according to the invention in accordance with a first embodiment, which is configured for filling transport means 20. The transport means 20 are shown here in the form of containers as an example. These containers 20 are moved in a transport direction 121 via a transport device 107. The transfer system 100 also comprises several transfer devices 104 or 104a-104f, here a total of six, which are each arranged in the transfer system 100 via suspensions not shown here. The number, arrangement, and configuration of the transfer devices 104a-104f can be varied as required and, in particular, depending on the size of the transfer system 100. In the present case, the transfer devices 104 are configured, for example, with arms 114.

On a product supply device 106, which moves in FIG. 1 in the conveying direction 120 of the product supply device 106 from left to right, products 26 are delivered, which are distributed irregularly and arranged in different rotational positions on the product supply device 106.

With the aid of the multiple transfer devices 104a-104f arranged at intervals along the product supply device 106, these products 26 are transferred in a correct rotational position into the containers 20 provided for this purpose, which in this case move in the transport direction 121 of the transport device 107 parallel to the product supply device 106.

For this purpose, the containers 20 are mounted on transport carriages 1 or 1a, 1b, 1c of the transport device 107 and are preferably filled during transport by means of the suction heads 103 of the transfer devices 104a-104f shown in FIG. 2, which suck up or grasp a suitable product 26 in their transfer area 102 on the product supply device 106, pick it up and place it in a suitable free position of a transport means 20. This process is shown schematically in FIG. 2 using the transfer device 104a.

The movements of the transfer devices 104 and the individual transport carriages 1a, 1b, 1c of the transport device 107 and, if necessary, also the speed of the product supply device 106 are controlled by control and drive devices 111. Input information is continuously monitored by means of a sensor or a camera 108, for example a line scan camera, before the products 26 enter the transfer area of the transfer devices 104, with regard to number, position, and rotational position of the products 26 under the scanning line extending across the entire transport direction. The input information is reported to the control and drive devices 111, which then control the individual transfer devices 104a-104f, taking into account the existing speeds of the product supply device 106 and the transport slides 1a, 1b, 1c. However, the control of the product supply device 106, in particular its conveying speed, can also be carried out by separate control and drive devices (not shown).

For normal operation, for each transfer device 104, an available actual transfer area 102 in conveying direction 120 is defined for each transfer device 104, which serves to avoid a collision with adjacent transfer devices 104a-104f. The potential transfer area 101 of each transfer device 104, on the other hand, is significantly larger and can be enabled by the control and drive devices 111 in individual cases, which then requires a corresponding control of the adjacent transfer devices 104 in order to avoid collisions.

The transport carriages 1a, 1b, 1c carrying the containers 20, which are guided on the same transport device 107, can move independently of each other and do not have to be moved in the same transport direction 121, so that a single transport means 20 including the transport carriage, e.g., 1b, can also move briefly in the opposite direction to the other transport carriages 1a and 1c running on the same transport device 107.

As can be seen in the sectional views of the transport device 107 in FIG. 2, the transport device 107 consists of a track body 11, 12, 13 with a substantially rectangular cross section in this case, on which a guideway 2a, 2b is formed on both the upper side and the lower side of the track body 11, 12, 13, on which the transport carriages 1 can be moved.

The upper guideway 2a serves to transport the containers 20, which are filled with products 26 by means of the suction heads 103 of the transfer devices 104, while the lower guideway 2b serves to return the empty transport carriages, e.g. 1b, to the start of the transport device 107. To ensure that the transport carriages 1 can also be moved independently of each other within the same guideway, e.g., 2a, they are separated, whereby all drives are also connected to the control and drive devices 111 of the transfer system 100. With regard to the configuration and mode of operation of the transport carriages 1, the guideways 2a, 2b, and the track bodies 11, 12, 13, explicit reference is made here to DE 10 2011 014 697 A1 of the present applicant.

The transport device 107 of the transfer system 100 has a first section 112 and a second section 113, which are arranged adjacent to the product supply device 106 on one side thereof and, as can be seen from FIG. 1, are both parallel to each other and parallel to the product supply device 106. The two sections 112, 113 differ in particular in that the first section 112 is configured as a section running in the same direction as the conveying direction 120 of the product supply device 106 and the second section 113 is configured as a section running in the opposite direction.

Accordingly, the two sections 112, 113 differ with regard to the transport direction 121 of the containers 20 relative to the conveying direction 120 of the product supply device 106. Along the first section 112, the containers 20 are moved by the transport device 107 in the conveying direction 120 of the product supply device 106 and thus according to the synchronous principle. In contrast, the containers 20 move along the second section 113 in the opposite direction to the conveying direction 120 and thus according to the counter principle. The transfer system 100 shown thus combines the principles of synchronous and counter transfer systems by using a single transport device 107.

During operation of the transfer system 100, the transfer devices 104 are controlled by the control and drive devices 111 in such a way that the containers 20 are filled in both the first and second sections 112, 113. Since the containers 20 first pass through the first section 112 as shown in FIG. 1, the filling of the containers 20 consequently begins in this section and can then be completed when passing through the second section 113.

Via their arms 114, the transfer devices 104 reach the first or second section 112, 113, depending on which section 112, 113 the respective transfer device 104 is assigned to, so that the transfer areas 102 of the transfer devices 104 extend to one of the two sections 112, 113 of the transport device 107, as shown in FIG. 1. In other words, the transfer devices 104a, 104b, 104c of the upper row in FIG. 1 transfer the products to the first section 112 and the transfer devices 104d, 104e, 104f of the lower row in FIG. 1 transfer them to the second section 113. Alternatively, it is also possible that the transfer area of a transfer device 104 relates to both sections 112, 113 and that the transfer devices 104 can accordingly serve both sections 112, 113.

The control of the transfer devices 104 and the product supply device 106 is generally carried out in view of maximizing the efficiency of the transfer system 100. In this context, it is important to avoid frequent braking of the product supply device 106 and an overflow of products 26 on the product supply device 106. These two undesirable conditions are generally known in transfer systems that operate entirely according to the synchronous principle. In the present transfer system 100 of the first embodiment, which combines the synchronous principle and the counter principle, it has been found that the provision of the second, counter section 113 is sufficient to negate the undesirable characteristics of the first, synchronous section 112 in such a way that the transfer system 100 operates with high efficiency.

The camera 108 or, if applicable, a plurality of cameras 108 is also configured to monitor the product supply device 106, the transferring of the products 26 in the first section 112, and the transferring of the products 26 in the second section 113. Based on the data generated from the monitoring, the transport speed of the products 26 on the product supply device 106, the transport speed of the containers 20 on the transport device 107, and the transfer speed of the transfer devices 104 can then be controlled.

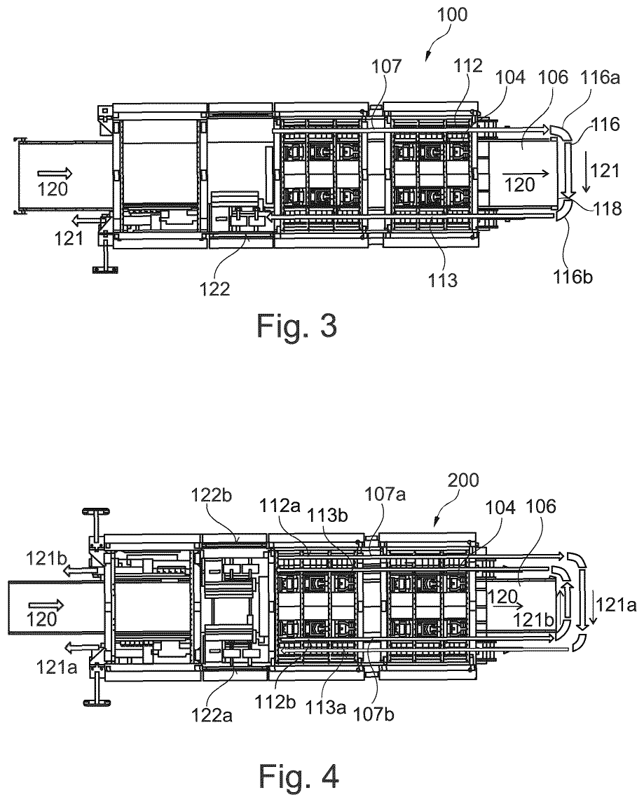

FIG. 3 now shows an example of a complete transfer system 100 according to the first embodiment in a top view. In FIG. 3, the transfer system 100 comprises a plurality of transfer devices 104, each of the transfer devices 104 being assigned its own transfer area 102 (not shown here). The transport device 107 is shown here schematically in the form of arrows, which indicate the transport direction 121 of the transport means (not shown) along the various sections 112, 113, 116 of the transport device 107.

In this first embodiment, the transfer devices 104 are all arranged in such a way that they transfer the products (not shown here) on the product supply device 106 conveyed in transport direction 120 in the first section 112 or in the second section 113 of the transport device 107. Accordingly, certain transfer devices 104, in this case the upper row comprising six transfer devices 104, transfer according to the synchronous principle, while the lower row, also comprising six transfer devices 104, operates according to the counter principle.

The first and second sections 112, 113 of the transport device 107 are connected to each other via a third section 116, so that the transport means 20 (see FIG. 1) pass through the first section 112 at the beginning of the transport device 107, then the third section 116, and finally the second section 113. In contrast to the first and second sections 112, 113, which are arranged parallel to each other and to the product supply device 106, the third section 116 is formed on a face side by one end 118 of the product supply device 106, as shown in FIG. 3. The three sections 112, 113, 116 form a U-shaped arrangement in plan view, with the third section 116 being formed substantially at right angles to the first and second sections 112, 113.

By arranging the third section 116 immediately adjacent to the face-side end 118 of the product supply device 106, a space-saving transition between the first section 112 and the second section 113 is achieved, as well as a smooth transfer of the transport means 20 from the first, synchronous section 112 to the second, counter section 113. For this purpose, the third section 116 has a transition area 116a, 116b at each of its two ends, which are configured to facilitate the transfer of the transport means 20 from the first section 112 to the third section 116 and from the third section 116 to the second section 113, respectively. The third section 116 is configured, for example, analogously to the rest of the transport device 107 as a chain conveyor or has other manipulating means, for example at least one robot arm (not shown), which picks up the containers 20 at the end of the first section 112 and transports them along the transport direction 121 to the beginning of the second section 113.

FIG. 3 also shows that a manipulation unit 122 is provided immediately after the second section 113, which is configured to further process the filled transport means 20 subsequently to the transferring process, for example by packaging them using a tubular bag machine or preparing them for a downstream packaging process, and to remove them from the transferring system 100.

Not shown in FIG. 3, but optionally possible, is the provision of a second manipulation unit 122, which is arranged relative to the manipulation unit 122 shown opposite the product supply device 106 adjacent to the beginning of the first section 112 of the transport device 107. This additional manipulation unit 122 then receives transport means 20 for further processing when the transport direction 121 of the transport device 107 is inverted. In the course of inverting the transport direction 121, the second section 113 consequently becomes the synchronous section and the first section 112 becomes the counter section. This can be particularly useful if the manipulation unit 122 actually intended for use has to be deactivated due to a malfunction, since in this case the operation of the transport means 20 can be continued seamlessly by inverting the transport direction 121.

Finally, FIG. 4 shows a second exemplary embodiment of a transfer system 200, which differs from the transfer system 100 of the first exemplary embodiment only in the provision of a first and a second transport device 107a, 107b, which is why reference is made to the explanations of the first exemplary embodiment with regard to all common features.

The two transport devices 107a, 107b are essentially redundant, adjacent and arranged parallel to each other and are configured to move transport means 20 independently of each other for transferring by transfer devices 104 along a respective transport direction 121a, 121b. The first transport device 107a is configured to transport transport means 20 along a first transport direction 121a and comprises, in the transport direction 121a, a first section 112a, a second section 113a, and then a first manipulation unit 122a in succession. The second transport device 107b is configured to transport transport means 20 along a second transport direction 121b and comprises, in the transport direction 121b, a first section 112b, a second section 113b, and then a second manipulation unit 122b in succession.

The provision of a second transport device 107b serves primarily to continue transferring products 26 from the product supply device 106 to transport means 20 by the transfer devices 104 in the event of failure or maintenance of the first transport device 107a without any loss of performance of the transfer system 200. Therefore, both the first and second transport devices 107a, 107b are comprised by the respective transfer areas 102 of the transfer devices 104.

Camera 108 shown in FIG. 1 or another sensor or another camera can be provided to detect a failure of the first or second transport device 107a, 107b, such that the transferring system 200 automatically switches from the first to the second transport device 107a, 107b or vice versa.

Finally, it should be noted that parallel operation of the first and second transport devices 107a, 107b is also conceivable if this is useful or necessary for operational reasons. The number and configuration of the transfer devices 104 of the first and second exemplary embodiments is also not fixed. For example, the transfer devices can be configured to fill transport means 20 in the first section 112 and/or in the second section 113. If desired, at least one transfer device 104 may also be provided, which fills transport means 20 in the third section 116.

1. Transfer system for transferring products to transport means which accommodate a specific amount of products, wherein the transfer system comprises:
at least one moving product supply device on which the products can be conveyed along a conveying direction;
at least one transport device which is configured to move the transport means; and
at least one transfer device for transferring the products from the product supply device to the transport means in a transfer area,
wherein the transport device moves the transport means at least through the transfer area,
wherein the product supply device and the transport device run parallel to each other at least in sections, and
wherein the transport device has at least a first section along which the products are transported by the transport means in the conveying direction of the product supply device and at least one second section along which the products are transported by the transport means in the opposite direction to the conveying direction of the product supply device.

2. Transfer system according to claim 1,
wherein a third section of the transport device extends between the at least one first section and the at least one second section, which is configured to transfer the products from the first section to the second section.

3. Transfer system according to claim 2,
wherein the third section of the transport device is arranged at a face-side end of the transfer system so that the transport device is circumferentially formed on the face side of the transfer system.

4. Transfer system according to claim 2,
wherein the first, second, and third sections form a U-shaped arrangement when viewed from above the transfer system.

5. Transfer system according to claim 2,
wherein the third section for transferring the products from the first section to the second section is formed with manipulating means, and
wherein the manipulating means comprise at least one selected from the group consisting of: link or curved chains, curved belts, or a robot.

6. Transfer system according to claim 1,
wherein the transfer area comprises the first and second sections of the transport device,
or wherein the transfer area comprises the first, second, and third sections of the transport device.

7. Transfer system according to claim 1,
wherein the at least one transfer device is configured to fill transport means in both the first section and the second section of the transport device,
or wherein the at least one transfer device is assigned only to the first section or only to the second section of the transport device.

8. Transfer system according to claim 1,
wherein at least one manipulation unit is arranged downstream of the second section of the transport device, which is configured to manipulate the products or the transport means filled with products, in particular to package them.

9. Transfer system according to claim 1,
wherein the transport device comprises transport carriages which can be moved independently of one another along the transport device, and
wherein each transport carriage is configured to move at least one transport means, and/or
the transport device comprises at least one first guideway and at least one second guideway, each of which is configured to accommodate a plurality of transport carriages and to move them independently of one another,
wherein the first guideway accommodates those transport carriages which move transport means to be filled with products, and the second guideway accommodates those transport carriages which return empty transport means to a start of the first guideway, and
wherein the first and second guideways are arranged above each other or are arranged side by side.

10. Transfer system according to claim 1,
wherein the transport device is configured to invert a transport direction of the transport means.

11. Transfer system according to claim 1,
wherein the transport device comprises a first transport device and a second transport device separate from the first transport device, and
wherein the first transport device and the second transport device each have at least one first section along which the products are transported by the transport means in the conveying direction of the product supply device and at least one second section along which the products are transported by the transport means in the opposite direction to the conveying direction of the product supply device.

12. Transfer system according to claim 11,
wherein a first manipulation unit is arranged downstream of the second section of the first transport device, which is configured to manipulate, in particular to package, the products transported by the first transport device, and a second manipulation unit is arranged downstream of the second section of the second transport device, which is configured to manipulate, in particular to package, the products transported by the second transport device.

13. Transfer system according to claim 11,
wherein the first section of the first transport device and the first section of the second transport device are arranged on different sides of the product supply device relative to a longitudinal central axis of the product supply device, or/and
wherein the second section of the first transport device and the second section of the second transport device are arranged on different sides of the product supply device relative to a longitudinal central axis of the product supply device, or/and
wherein the first manipulation unit and the second manipulation unit are arranged on different sides of the product supply device relative to a longitudinal central axis of the product supply device.

14. Transfer system according to claim 1,
wherein the transfer system comprises at least one camera or sensor which monitors the transferring of the products in the transfer area.

15. Method for transferring products to transport means by means of at least one transfer device of a transfer system, in particular a transfer system according to claim 1, wherein the method comprises:
moving the transport means to be filled by means of at least one transport device through at least one transfer area in which the transfer device is arranged; and
filling the transport means by the transfer device transferring products from at least one moving product supply device, which runs at least partially parallel to the transport device, to the transport means to be filled,
wherein the products are transferred to the transport means both in a first section along which the products are transported by the transport means in a conveying direction of the product supply device, and in a second section of the transport device, along which the transport of the products by the transport means runs in the opposite direction to the conveying direction of the product supply device.

16. Method according to claim 15,
wherein the transport means are moved by means of the transport device from the first section to the second section via a third section of the transport device, wherein the third section is preferably arranged on a face side of the transfer system such that the transport device extends circumferentially on the face side around the transfer system.

17. Method according to claim 15,
wherein first control and drive devices are configured for driving the product supply device and the transport device, and the transport speed of the products on the product supply device is controlled independently of the transfer speed of the transfer device in the first and second sections of the transport device,
and wherein the transport speed of the transport means is preferably controlled based on the transfer speed of the last transfer device along the transport direction of the transport means.

18. Method according to claim 15,
wherein the at least one transfer device is controlled via second control and drive devices in such a way that the filling of a transport means is prioritized as long as the transport means is located in the first section of the transport device.

19. Method for transferring products to transport means by means of at least one transfer device of a transfer system according to claim 11,
wherein the operation of the transfer system is switchable between a first operating mode, in which the transfer device transfers the products only to transport means of the first transport device, while the second transport device and/or the second manipulating unit is/are preferably inactive, and a second operating mode, in which the transfer device transfers the products only to transport means of the second transport device, while the first transport device and/or the first manipulating unit is/are preferably inactive.

20. Method according to claim 19,
wherein switching from the first operating mode to the second operating mode is performed substantially without interruption of the movement of the product supply device.
